(19) United States
(12) Patent Application Publication
(10) Pub. No.: US 2012/0263828 A1
(43) Pub. Date: Oct. 18, 2012

(54) Stabilization of Oil in Water Microparticles Using Natural Polymeric Polyphenols

(76) Inventors: Donald E. Ackley, Cardiff, AZ (US); Eugene Tu, San Diego, CA (US)

(21) Appl. No.: 13/448,683

(22) Filed: Apr. 17, 2012

Related U.S. Application Data
(60) Provisional application No. 61/476,303, filed on Apr. 17, 2011.

(51) Int. Cl. A23L 2/44; A23L 1/303; A23L 1/302; A23F 3/00

(52) U.S. Cl. 426/73; 426/545

(57) ABSTRACT

A method of stabilizing nutritional drinks, and the stabilized drink, including the steps of forming edible oil microparticles, dissolving polyphenol concentrate in a liquid, and associating the polyphenol from the concentrate with the microparticles in the liquid to prevent free radicals from reaching the surface of the microparticles.

### CROSS-REFERENCE TO RELATED APPLICATION

This application claims the benefit of U.S. Provisional Patent Application No. 61/476,303, filed 17 Apr. 2011.

### FIELD OF THE INVENTION

This invention relates to nutritional beverages.

More particularly, the present invention relates to nutritional suspensions in beverages.

### BACKGROUND OF THE INVENTION

At the present time energy drinks, functional waters and supplement drinks are very popular worldwide. The major problem is that many supplements are water insoluble which greatly reduces bioavailability, constrains delivery mechanisms, requires costly additives to increase solubility and/or reduces appeal to customers focused on organic products. This severely limits the opportunity to create new brands targeting lifestyles, younger demographics, etc. In the present invention, nutritional drinks including edible oil in water microparticles are of particular interest.

Edible oil in water microparticles may be formed using the method disclosed in U.S. patent application entitled “WATER SOLUBLE DRUGS AND SUPPLEMENTS”, Ser. No. 12/545,650, filed 21 Aug. 2009, and U.S. patent application entitled “WATER SOLUBLE STATIN MICROSTRUCTURES AND METHOD OF PREPARATION”, Ser. No. 12/607,403, filed 28 Oct. 2009, both herein incorporated by reference. Of particular interest are oil in water microparticles containing omega3s such as fish oil, algal oil, krill oil, and flax seed oil, or other supplement oils such as tocopherols (Vitamin E) and retinols (Vitamin A). The microparticles are formed by dissolving the edible oils in ethanol, combining them with water, and subsequently removing the ethanol by evaporation or the like. These all natural oil in water microparticles utilize no surfactants or encapsulants and are stable for months in water, but are seen to degrade under conditions often encountered in the formulation and packaging of ready to drink beverages.

In particular, ready to drink beverages often have high acidity as characterized by pH in the range of 2.8-3.6, which is mostly achieved by the addition of citric acid. Also, many ready to drink beverages are hot filled at temperatures in the range of 80-95 C to preserve them against microbial growth. Both of these conditions can degrade the properties of the microparticles that are present in the beverages. In particular, the microparticles can aggregate, causing the beverages to become more opaque and hence less desirable. These aggregates tend to float and create the undesirable effect known in the beverage industry as “ringing” whereby the particles form a visible ring at the top of the beverage bottle. Aggregated particles are also more likely to further aggregate over a period of time and eventually form droplets which are no longer soluble in water, rendering the beverage unsatisfactory for consumption.

Another mode of degradation of oil in water microparticles is oxidation of the edible oils after they are packaged, due to oxygen retained in a container. This is a particular issue for oil in water concentrates which may be offered so that a consumer can add the concentrate to the beverage of his choice. In order to prevent oxidation, expensive packaging is often used, sometimes with caps that absorb oxygen, and often with a purge gas such as nitrogen to displace oxygen in the container and minimize oxidation of the oils.

It is therefore desirable to find additional means to stabilize oil in water microparticles.

Accordingly, it is an object of the present invention to provide new and improved stabilization methods and materials to stabilize oil in water microparticles.

It is another object of the present invention to provide stabilization for drink beverages having high acidity and ready to drink beverages that are hot filled.

It is another object of the present invention to provide reduced oxidation of edible oils after they are packaged.

It is another object of the present invention to prevent the aggregation of the microparticles and subsequent degradation in the clarity of drinks containing the microparticles.

### SUMMARY OF THE INVENTION

Briefly, to achieve the desired objects of the instant invention in accordance with a preferred embodiment thereof, a method of stabilizing nutritional drinks is disclosed. The method includes the steps of forming edible oil microparticles, providing a polymeric polyphenol solution, typically comprising a concentrate, and a liquid, and associating the polymeric polyphenols in the concentrate solution with the microparticles in the liquid to form a stabile nutritional drink in which free radicals are prevented from reaching the surface of the microparticles. In the method, the step of “associating” includes combining the microparticles, the polyphenol solution, and the liquid in any order to form the stabile nutritional drink.

The desired objects of the instant invention are further realized in accordance with an embodiment thereof in which a stabilized nutritional drink includes edible oil microparticles, polyphenol concentrate, and a liquid and the polyphenol concentrate is associated with the microparticles in the liquid to provide a stabile nutritional drink. It should be noted that the association of the polyphenol concentrate and the microparticles in the liquid prevent free radicals from reaching the surface of the microparticles which results in improved stabilization including reduced oxidation of edible oils after they are packaged and the prevention of the aggregation of the microparticles and subsequent degradation in the clarity of drinks containing the microparticles.

### DETAILED DESCRIPTION OF A PREFERRED EMBODIMENT

Polymeric polyphenols are found in a variety of natural products. Of particular interest is a class of polymeric polyphenols known as tannins, which can be classified as oligomeric or polymeric proanthocyanidins. Proanthocyanidins can be found in many plants, most notably apples, maritime pine bark, cinnamon, cocoa, grape seed, grape skin and red wines where tannins are well known to aid in the desirable aging process. However, bilberry, cranberry, chokeberry, black currant, green tea, black tea, and other plants also contain proanthocyanidins in various structural forms. We have found that, in particular, the polyphenols found in black teas can act as stabilizing agents for oil in water microparticles in ready to drink beverages. However, the molecular structure of the proanthocyanidins in cranberry and grape skin suggest they may also exhibit stabilizing properties.

Teas, typically from the species Camellia sinensis, are particularly useful to enhance the oxidative and physical stability of omega3 microparticles. The polyphenols found in teas are powerful antioxidants, the mix of which is varied according to the amount of enzymatic oxidation the tea undergoes during processing. Green tea is not oxidized during processing and contains a high percentage of catechins such as epigallocatechin gallate. Black tea, on the other hand, is nearly completely oxidized during processing. During the oxidation process, green tea catechins are converted to anti-oxidant polyphenols known as theaflavins and the polymeric polyphenols known as thearubigins. Black teas solids are typically 60% thearubigins, which are water soluble polymers thought to have average molecular weights in the range of 700-2000 Da (E. Haslam, Thoughts on Thearubigins, Phytochemistry 64 (2003) 61-731). In the fundamental discovery of this invention, these black tea polyphenols associate with the microparticles formed using the process and prevent free radicals from reaching the surface of the microparticles where they might oxidatively degrade the molecules residing at the surface. In addition, by associating with the microparticles, the microparticles are prevented from contacting one another, preventing the aggregation of the particles and subsequent degradation in the clarity of drinks containing the microparticles.

While black teas have been shown to be advantageous for stabilizing omega3 microparticles, other partially oxidized teas such as Oolong or other fully oxidized teas such as Puer tea may also have advantageous properties.

Red grapes are also important sources of polyphenols. Grape skin extract, which has more highly polymerized polyphenols than other portions (seed, pulp) of the grape, has been observed to provide some degree of stabilization to oil in water microparticles in acidic environments.

Polymerization of food polyphenols is often connected with oxidation, for example by the aforementioned enzymatic oxidation as in the production of black tea, but also by heating such as that which is used in roasting coffee. Coffee has also exhibited stabilizing effects on microparticles in low pH environments. Cocoa, which also often undergoes a fermentation step, is another excellent candidate to stabilize oil in water microparticles. Cinnamon bark, which also has a high degree of polymerized polyphenols, may also act as a stabilizing agent.

The stabilizing advantages of teas may be achieved by merely adding microparticle concentrate to a prepared tea beverage, preferably a tea beverage that is to be bottled or canned. However, to gain the stability advantages of tea in any water based beverage, a particularly advantageous form of tea that can be used in the process is tea concentrate, which can be as much as 128 times more concentrated than teas that are for consumption. These concentrates are routinely used in iced tea dispensers, for example. In the present invention, small volumes of tea concentrate may be incorporated into the process to improve the stability of the microparticles in any water-based prepared beverage, including waters, sodas, sports drinks, energy drinks, and packaged juices.

The stabilizing effects of teas and other polymeric polyphenols are effective against pH, high temperature processing, and oxidative degradation. In stabilization against pH, the use of black tea prevents aggregation and breakdown of the oil in water oil particles in acidic beverages and is especially effective in stabilizing the microparticles against the carboxylic acids found in most beverages. These include citric acid which is added to most beverages for tartness, malic acid which is found in apple juice, tartaric acid, acetic acid, and various citrates which are often used as preservatives.

Teas also act as effective stabilizing agents against high temperature processing. Many beverages (teas, juices, energy drinks, sports drinks) are hot-filled at temperatures in the range 80-95 C to prevent microbial growth and mold.

In conjunction with acidic environments of pH <4.6, hot filling prevents the growth of botulism and mold. However, hot packing temperatures have been shown to cause aggregation of the oil in water microparticles, especially when the emulsions are in beverages that have higher acidity. For example, apple juice containing omega3 microparticles filled at temps >85 C will aggregate and degrade, with substantial decreases in the clarity of the juice. Typically, these juices are supplemented by adding a concentrate of oemga3 microparticles. Particle sizes as measured by dynamic light scattering increase from 150 nm to 400 nm after the juices are hot-filled, sealed, and cooled. However, the addition of concentrated black tea (brewed black tea concentrated to 128× normal strength, which can be decaffeinated or not) to the apple juice, or to the omega3 concentrate, prevents aggregation and particle degradation. Drinks remain clear and the particle size is unchanged during the hot fill process.

Typically, oil in water microparticles are made as concentrates with oil concentration by weight in the range of 5-40 mg/ml. Particle size and monodispersity can be degraded during the ethanol injection process at high initial omega3 in ethanol concentrations. These concentrates tend to be unstable with slowly increasing average particle size and eventually, oil droplet precipitation. In teas and apple juice, this phenomenon is characterized by “ringing”, i.e. the formation of light colored rings of larger oil microparticles at the surface of the drink. Ringing is accelerated by low pH and high temperature and is considered highly undesirable for product, and can even occur in stable drinks over the course of months. The addition of concentrated black tea prevents the long term degradation of these higher concentration microparticle drinks without affecting the flavor or aroma of the juice.

Omega3 microparticles can be used to form highly desirable functional bottled teas with concentrations as high as 0.5 g of omega3s in a 16 oz bottle of tea. Of course, bottled teas come in many formats, using green, black, white, and red teas, high concentrations of citric acid to provide “brightness” to the teas, and various citrus flavors. Often the highest concentration ingredient after water is not even tea, but can be citric acid. Omega3 functional drinks made with green teas often turn out to be unstable, with significant clouding of the teas occurring over time periods ranging from minutes to a few weeks. This is typically accompanied by degradation in the “nose” of the teas by a fishy odor that results from oxidation of the omega3 fatty acids. The addition of a percentage of black tea to the green teas can prevent clouding and olifactory degradation of the green teas. Typical percentages of black tea to prevent destabilization of the omegas in green tea are 5-40%. The black tea can either be added at a normally brewed strength, or as a concentrate as described earlier. If concentrate is used, usually at 128×, the percentage concentrate by volume can be in the range of 0.04%-0.4% by volume. Understanding that teas are natural products, these percentages are typically optimized for different tea formulations and flavors.

Black teas may also be used to oxidatively stabilize omega3 microparticle concentrates. While microparticle concentrates can be stable for periods exceeding six months, they are quite sensitive to oxygen and can degrade when exposed to air. As a result, care must be taken during formulation and packaging of commercial concentrate products to minimize exposure to air, particularly if the concentrates are heated. Often nitrogen purging is used to minimize oxidation. We have found that the addition of concentrated black tea at 128× can substantially reduce the oxidation of omega3 concentrates deliberately exposed to air over periods of months. Black tea added to omega3 concentrates at percentages in the range of 0.25-2.5% by volume can substantially reduce oxidative degradation as measured by the presence of a “fishy” odor.

Soft drinks and energy drinks typically use citric acid to provide tartness, improve flavor, and prevent microbial growth. The pH of some soft drinks can be as low as 3.0. Omega3 microparticle emulsions are immediately degraded by the low pH of these drinks, i.e. the drinks become instantly cloudy when omega3 concentrate is added. The addition of black tea or concentrated black tea to the drinks before the omega3 concentrate is added can prevent degradation. The amount of tea necessary to prevent cloudiness is basically determined by the pH of the drink, i.e. a lower pH requires a higher percentage of tea. The range of 128× black tea concentrate required is typically 0.03%-0.32% depending on the pH. For example, a test sample made with 0.15% anhydrous citric acid by weight can be stabilized against clouding by adding 0.32% of 128× black tea concentrate by volume. Similarly, for an energy drink with less citric acid, 0.16% of 128× by volume concentrated black tea is sufficient for stabilization.

Following are some specific examples of the use of black tea to stabilize beverages with omega3 microparticles.

### EXAMPLE 1

Fish oil with an omega3 fatty acid content between 30 and 40% is dissolved in ethanol at a concentration of 12.5 mg/ml at room temperature. A 128× liquid tea concentrate is dissolved in water at a concentration of 0.5%-5.0% by volume. The omega3 solution is combined with the tea solution at a volume ratio of 1:2 to form stable microparticles. The ethanol is removed as needed, typically by some form of evaporation such as rotary evaporation or the like.

### EXAMPLE 2

Fish oil with an omega3 fatty acid content between 35% and 45% is dissolved in ethanol at a concentration of 12.5 mg/ml at room temperature. Liquid tea concentrate at a concentration of 2.5%-5.0% by volume is added to the ethanol solution. The solution containing both omega3s and tea concentrate is combined with water at a volume ratio of 1:2 to form stable microparticles. The ethanol is removed as needed, typically by some form of evaporation such as rotary evaporation or the like.

### EXAMPLE 3:

Microparticles of fish oil with omega3 fatty acid content between 35% and 45% are formed by the mixing process described herein. After microparticle formation and ethanol removal, tea concentrate is added at 0.25% -1.0% by volume to stabilize the microparticle concentrate.

### EXAMPLE 4

Black tea concentrate is added to apple juice at a concentration of 0.5%-5.0%. The apple juice is heated to 85° C.-100° C. to prevent microbial growth. Omega 3 microparticle concentrate is added to achieve a weight fraction of 0.4 mg/ml. The resulting product is hot-filled and cooled to room temperature. The resulting juice with omega3 microparticles retains its clarity for a minimum of 30 days storage at room temperature.

### EXAMPLE 5

Black tea concentrate is added to a soft drink mix prior to carbonation. The soft drink contains 100 g/L sucrose and 1.5 g/L anhydrous citric acid. Approximately 0.2%-2.0% by volume black tea concentrate is added and the solution heated to 90° C.-95° C. Omega3 microparticle concentrate is added at 0.5 mg/ml and the solution is hot-filled and cooled to room temperature. The soft drink mix retains its clarity for a minimum of 60 days storage at room temperature.

### EXAMPLE 6

Black tea concentrate is added to bottled green tea at a concentration of 0.16%-1.6%. Omega3 microparticle concentrate is added at a concentration of 0.5 mg/ml. The mixture has good clarity and retains its clarity under room temperature storage conditions for a period of least 75 days.

### EXAMPLE 7

Omega3 microparticle concentrates is added to bottled black teas, or bottled black teas that contain a mix of black and green teas, and also contain sugar or non-sugar sweeteners, citric acid and natural flavors. The omega3 concentrate fraction by weight is approximately 0.4 to 1.0 mg/ml. The teas retain their clarity and show no oxidative degradation under room temperature storage for at least 120 days.

### EXAMPLE 8

Black tea beverages containing black tea concentrate, lemon juice concentrate, lemon extract, and natural sweeteners are heated to 90° C.-100° C. Omega3 concentrate at a weight fraction of between 0.4-1.0 mg/ml is added and the mixture is hot-filled into bottles, sealed, and cooled in a water bath to room temperature. The bottled teas retain their clarity and flavor after the hot fill process and remain stable at room temperature for at least 120 days.

### EXAMPLE 9

Black tea concentrate, with a concentration in the range of 0.2%-2.0% by volume, is added to prototypical energy drinks containing caffeine, B-vitamins, citric acid, taurine, etc. Omega3 microparticle concentrate is added at 0.5 mg/ml. The energy drink mix retains its clarity for a minimum of 60 days storage at room temperature.

It should be understood that there are a variety of processes or steps (e.g. the arrangement of the step order) for combining edible oil microparticles, polyphenol concentrate, and a liquid to stabilize the microparticles. In this disclosure the term “associate, associated, or associating” is defined to mean mixing, dissolving, or combining in any order of microparticles, polyphenol concentrate, and a liquid to stabilize the microparticles. Further, the term “stabilize” includes providing reduced oxidation and preventing the aggregation of the microparticles.

Thus, new and improved stabilization methods and materials to stabilize oil in water microparticles have been disclosed. The new and improved stabilization methods and materials provide stabilization for drink beverages having high acidity and ready to drink beverages that are hot filled. The microparticles, polyphenol concentrate, and a liquid are associated to prevent free radicals from reaching the surface of the microparticles. Also, the new and improved stabilization methods and materials provide reduced oxidation of edible oils after they are packaged. Further, the new and improved stabilization methods and materials prevent the aggregation of the microparticles and subsequent degradation in the clarity of drinks containing the microparticles.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A method of stabilizing nutritional drinks comprising the steps of:
forming edible oil microparticles;
providing a solution of polyphenol;
providing a liquid; and
associating the polyphenol with the microparticles in the liquid to form a stable nutritional drink.

2. The method of claim 1 where the solution of polyphenol is a concentrate.

3. The method of claim 2 in which the step of associating includes combining microparticles, polyphenol concentrate, and liquid in any order to form the stabile nutritional drink.

4. A method of stabilizing nutritional drinks comprising the steps of:
dissolving polyphenol, or tannin, concentrate in a liquid, the concentrate having a concentration in the range 0.16%-5.0% by volume;
forming edible oil microparticles; and
adding the edible oil microparticles to the liquid.

5. A method as claimed in claim 4 wherein the step of forming edible oil microparticles includes dissolving an omega3 fatty acid in ethanol.

6. A method as claimed in claim 4 wherein the omega3 fatty acid includes at least one of fish oil, algal oil, and flax seed oil.

7. A method as claimed in claim 6 wherein the at least one of fish oil, algal oil, and flax seed oil includes omega3 fatty acid with a content between 30% and 40%.

8. A method as claimed in claim 7 wherein the step of adding the edible oil microparticles includes combining the omega3 fatty acid in ethanol and the polyphenol concentrate in the liquid at a volume ratio of 1:2.

9. A method as claimed in claim 8 including in addition a step of removing the ethanol.

10. A method as claimed in claim 4 wherein the step of dissolving polyphenol concentrate in the liquid includes dissolving a polymeric polyphenol concentrate in apple juice at a concentration of 0.5%-5.0%.

11. A method as claimed in claim 4 wherein the step of dissolving polyphenol concentrate in the liquid includes dissolving liquid tea concentrate in water at the concentration of 0.16%-5.0% by volume.

12. A method as claimed in claim 11 wherein the liquid tea concentrate is approximately 128× concentrated.

13. A method of forming a stabilized nutritional drink comprising the steps of:
dissolving an omega3 fatty acid in ethanol at a concentration of approximately 12.5 mg/ml at room temperature;
adding polymeric polyphenol, or tannin, concentrate having a concentration in the range 0.16%-5.0% by volume to the ethanol solution;
combining the solution containing both omega3 and polymeric polyphenol with a liquid at a volume ratio of 1:2 to form stable microparticles; and
removing the ethanol.

14. A method as claimed in claim 13 wherein the step of dissolving the omega3 fatty acid includes dissolving fish oil with an omega3 fatty acid content between 35% and 45%.

15. A method as claimed in claim 13 wherein the step of adding polymeric polyphenol includes adding liquid tea concentrate at a concentration of 2.5%-5.0% by volume to the ethanol solution.

16. A method as claimed in claim 13 wherein the step of removing the ethanol includes rotary evaporation.

17. A stabilized nutritional drink comprising:
edible oil microparticles;
a concentrate solution containing polyphenol;
a liquid; and
the polyphenol associated with the microparticles in the liquid to provide a stabile nutritional drink.

18. A stabilized nutritional drink comprising:
edible oil microparticles in water; and
polymeric polyphenol, or tannin, concentrate dissolved in the water, the concentrate having a concentration in the range 0.16%-5.0% by volume.

19. A stabilized nutritional drink as claimed in claim 18 wherein the polymeric polyphenol includes liquid tea.

20. A stabilized nutritional drink as claimed in claim wherein the liquid tea includes liquid black tea concentrate.

21. A stabilized nutritional drink as claimed in claim 18 wherein the edible oil microparticles include omega3s or supplement oils.

22. A stabilized nutritional drink as claimed in claim 21 wherein the omega3s include at least one of fish oil, algal oil, and flax seed oil.

23. A stabilized nutritional drink as claimed in claim wherein the supplement oils include at least one of tocopherols (Vitamin E) and retinols (Vitamin A).
